(19) United States
(12) Patent Application Publication
(10) Pub. No.: US 2009/0019742 A1
(43) Pub. Date: Jan. 22, 2009

(54) DESK ORGANIZER

(76) Inventor: Steen Stolsvig, Herning (DK)

Correspondence Address: WINSTON & STRAWN LLP;PATENT DEPARTMENT, 1700 K STREET, N.W., WASHINGTON, DC, 20006, US

(21) Appl. No.: 12/162,290

(22) PCT Filed: Jan. 24, 2007
(86) PCT No.: PCT/DK07/00029

§ 371 Date: Jul. 25, 2008

(30) Foreign Application Priority Data
Jan. 25, 2006 (DK) BA 2206 00027

(51) Int. Cl. B42F 13/12; A47F 7/16; A47F 5/02

(52) U.S. Cl. 40/379; 211/45; 211/163

(57) ABSTRACT

The present application regards a holder for example for filing of paper. The holder includes a bottom plate on which it is assembled a central rotating supporting plate. In the central of the two plates a vertical shaft is mounted. The supporting plate and the vertical shaft are rotatable in relation to the bottom plate. On the shaft one or more binder mechanism from ring binders are assembled vertically, that is alongside the shaft. The filing in the holder is done by placing the object to be filed into for example pockets of clear plastic, which is kept by the binder mechanism from the ring binders, which is assembled on the vertical and rotatable placed shaft.

The present description concerns a holder for archiving of paper as an example. The holder includes a bottom plate and on that, in the essential a central rotating fixed supporting plate with, in the essential vertical and central placed shaft.

Holder for achieving of this type, known from U.S. Pat. No. 6,296,127. The central placed vertical shaft in this document describes a holder caring circular sheets, placed on the shaft with a fixed distance between each other. The circular sheets earn to take up notes performed in the side parts of stick inn pocket of plastic. The stick inn pockets hold different types of documents, wanted for archiving in the holder.

Other similar known holders for archiving documents, known from:
U.S. Pat. No. 5,291,677, which show the use of horizontal archiving of photos, and
DE Open document no: 1963634, which show the use of a vertical archiving with fixed short stick in pocket holders.

The purpose with the present production is to show a holder for archiving of the above-mentioned known type with alternative mechanism to fixing subjects for archiving in the holder.

This purpose is achieved with a holder of the type described in the introduction, this is new for the reason, that over the supporting plate an in the essential parallel with the rotating shaft is fixed one or more binder mechanism from ring binders.

Archiving in the new holder is done in the way, what is to be archived will be placed into pockets of example clear plastic, which is hold by the binder mechanism from the ring binders, there is placed on the archive holders central placed rotation shaft.

The holder gives a quick general view on a big amount of papers, subjects or other documents which can be placed in the pockets, placed on the holder, for the reason that the holder can be rotated and the pockets can be indexed as needed, either with a collar, number or with letters.

This kind of a general view is heavily to achieve on a big amount of documents, placed in a pile on the desk or working place.

The new holder is in particular suitable fore working places, where the holder can be placed loose on the desk or working place or can be fixed on to it. By using the holder, on a relative small place there can be archived many papers, which as an example cut be documents/subjects, which are under current/running preparation.

Manufacturing of the holder can be of various suitable materials.

### FIGURES

The drawings consist of seven figures, (FIG. 1-7) that shows details, of the preferred form carried out on the present production.

FIG. 1 shows the holder for archiving from the side with the bottom plate, Rotable supporting plate, central placed rotating shaft and binder mechanism from ring binders.

FIG. 2 shows the holder for archiving from the top with the Rotable supporting plate, the central rotating shaft and four-binder mechanism from ring binders, placed spread around the rotating shaft.

FIG. 3 shows the holder for archiving in perspective.

FIG. 4 shows the holder for archiving in perspective with few pockets for archiving, fixed on one of the on the rotating shaft mounted binder mechanism, from ring binders.

FIGS. 5 and 6, shows the same as FIG. 4, it only viewed from different rotated angels.

FIG. 7 shows the holder for archiving in a central vertical cut with its constructions element.

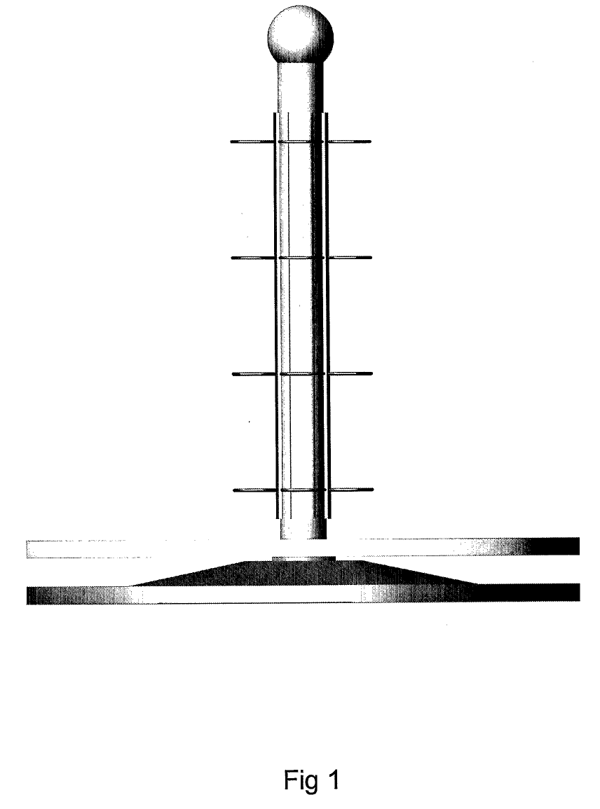

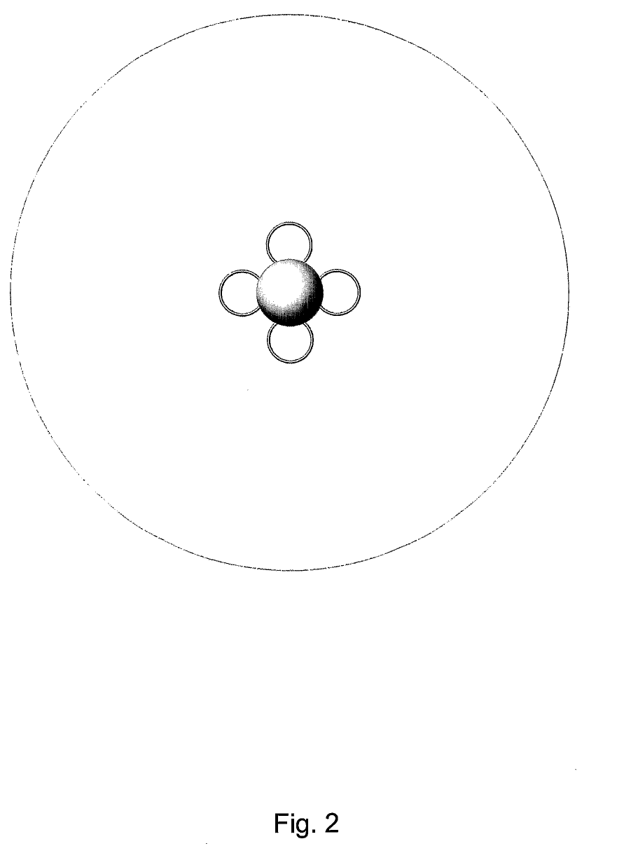

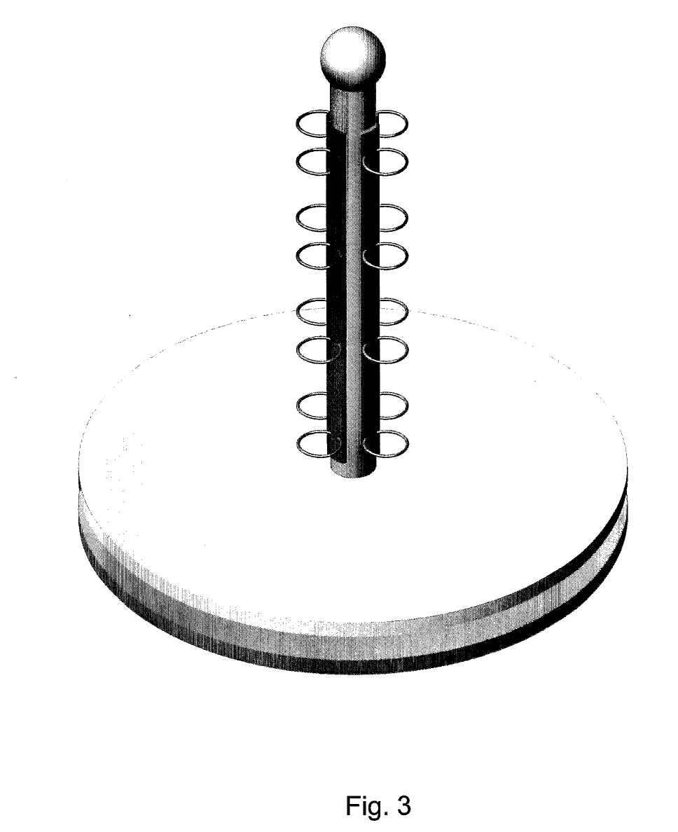

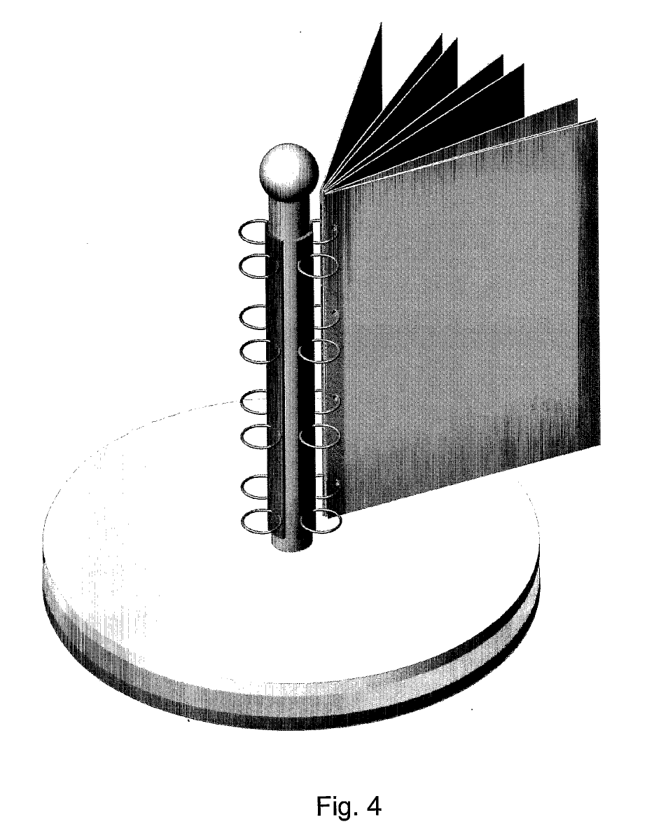

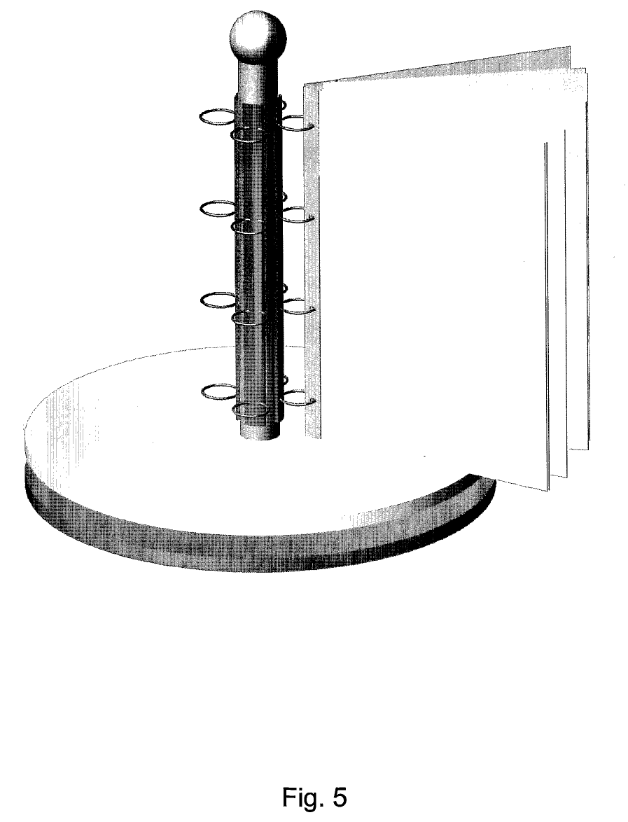

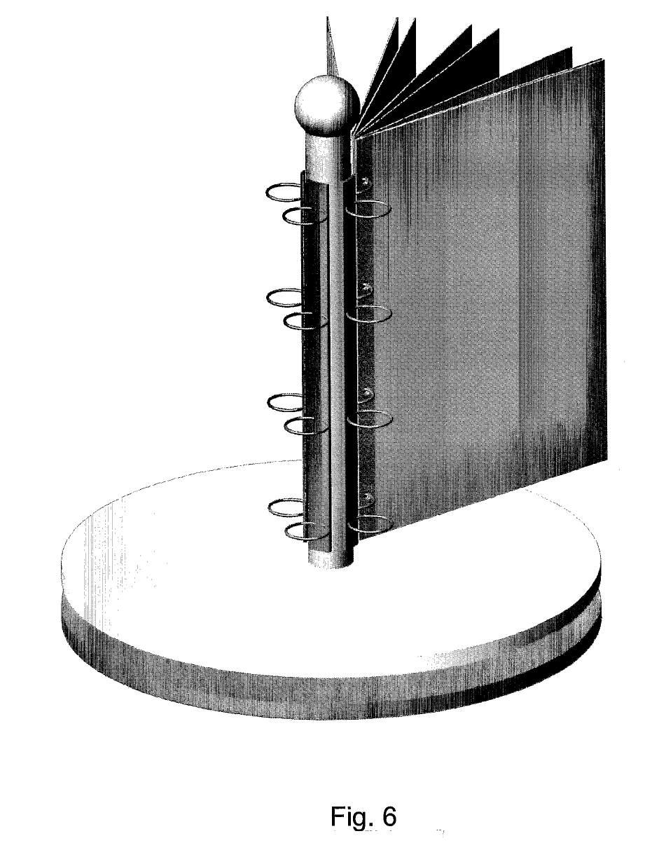

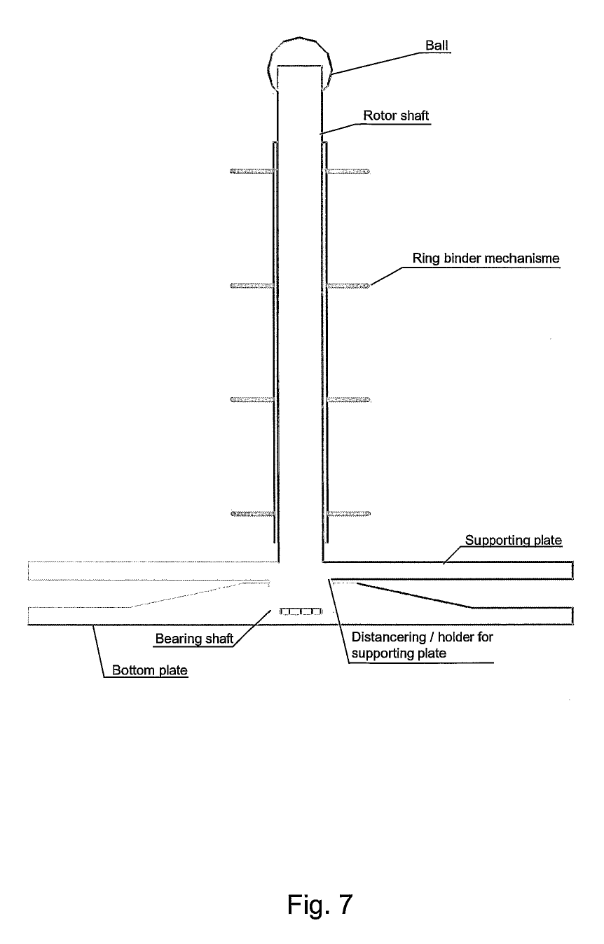

1-8. (canceled)

9. A holder for archiving comprising a bottom plate and a shaft, wherein
a substantially central placed supporting plate is located above the bottom plate,
the shaft is substantially vertical mounted substantially in the center of the bottom plate and the supporting plate,
the supporting plate and the shaft is rotatable in relation to the bottom plate, and
one or more binder mechanisms from ring binders is fixed on the shaft.

10. The holder for archiving according to claim 9, wherein the one or more binder mechanisms from ring binders are spread around the shaft.

11. The holder for archiving according to claim 9, wherein the number of binder mechanisms from ring binders are four.

12. The holder for archiving according to claim 9, wherein a distance ring is situated between the bottom plate and the supporting plate.

13. The holder for archiving according to claim 9, wherein the distance ring is a holder for the supporting plate.

14. The holder for archiving according to claim 9, wherein the shaft is supported by a bearing centrally located in the bottom plate.

15. A combination comprising the holder according to claim 9 and a plurality of document pockets.

16. The combination according to claim 15 wherein the document pockets include documents for archiving.
